(19) United States
(12) Patent Application Publication
(10) Pub. No.: US 2020/0049925 A1
(43) Pub. Date: Feb. 13, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/525,579

(22) Filed: Jul. 30, 2019

(30) Foreign Application Priority Data
Aug. 8, 2018 (CN) 201821271854.3

(51) Int. Cl. G02B 7/02; G02B 13/00

(52) U.S. Cl. CPC G02B 7/021; G02B 7/026; G02B 13/004

(57) ABSTRACT

Provided is a lens module, including a lens barrel having an optical axis, a lens accommodated in the lens barrel and a pressing ring. The lens includes a body portion for imaging and a peripheral portion extending around the body portion. The lens module has an imaging area, and a non-imaging area including the lens barrel, the peripheral portion and the pressing ring. The lens module further includes an extinction portion formed in the non-imaging area. A plurality of extinction bulges distributed in an array is formed by extending from a side of the extinction portion close to the optical axis towards the optical axis to, the plurality of extinction bulges being. An end surface of each of the plurality of extinction bulges close to the optical axis is an arc surface protruding in a direction facing away from the extinction portion.

### TECHNICAL FIELD

The present disclosure relates to the technical field of optical imaging, and in particular, to a lens module used in electronic devices such as a camera, a video camera, a mobile phone, a tablet computer or a laptop.

### BACKGROUND

In recent years, with the development of imaging technologies and the advance of electronic products with imaging functions, optical lens modules have been widely used in various products and have been continuously improved and optimized. At present, the improvement direction of most lens modules is: how to make the lens module smaller and thinner, how to select suitable lenses with good optical characteristic compatibility while making the lens module smaller and thinner, and how to combine the lenses to ensure a better imaging effect.

However, the inventors have found that in the process of imaging, the light incident from different angles to the lens module is extremely easy to form stray light interference, which may cause a great adverse effect on the imaging quality of the lens module. Although the current strategy is to reduce reflection of light at a light inlet of the lens module at present, stray light formed by repeated reflections of light incident into the lens module will still lower the imaging quality.

### BRIEF DESCRIPTION OF THE DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a lens module provided by an embodiment of the present disclosure;

FIG. 2 is a front view of a pressing ring provided by an embodiment of the present disclosure;

FIG. 3 is a perspective view of a pressing ring provided by an embodiment of the present disclosure;

FIG. 4 is an enlarged view of portion E shown in FIG. 3;

FIG. 5 is a cross-sectional view of a pressing ring provided by an embodiment of the present disclosure;

FIG. 6 is an enlarged view of portion F shown in FIG. 5;

FIG. 7 is a schematic diagram of an extinction bulge provided by a first embodiment of the present disclosure;

FIG. 8 is a schematic diagram of an extinction bulge provided by a second embodiment of the present disclosure;

FIG. 9 is a schematic diagram of an extinction bulge provided by a third embodiment of the present disclosure;

FIG. 10 is a schematic diagram of an extinction bulge provided by a fourth embodiment of the present disclosure; and

FIG. 11 is a schematic diagram of an extinction bulge provided by a fifth embodiment of the present disclosure.

### DETAILED DESCRIPTION

The present disclosure will be further illustrated with reference to the accompanying drawings and the embodiments.

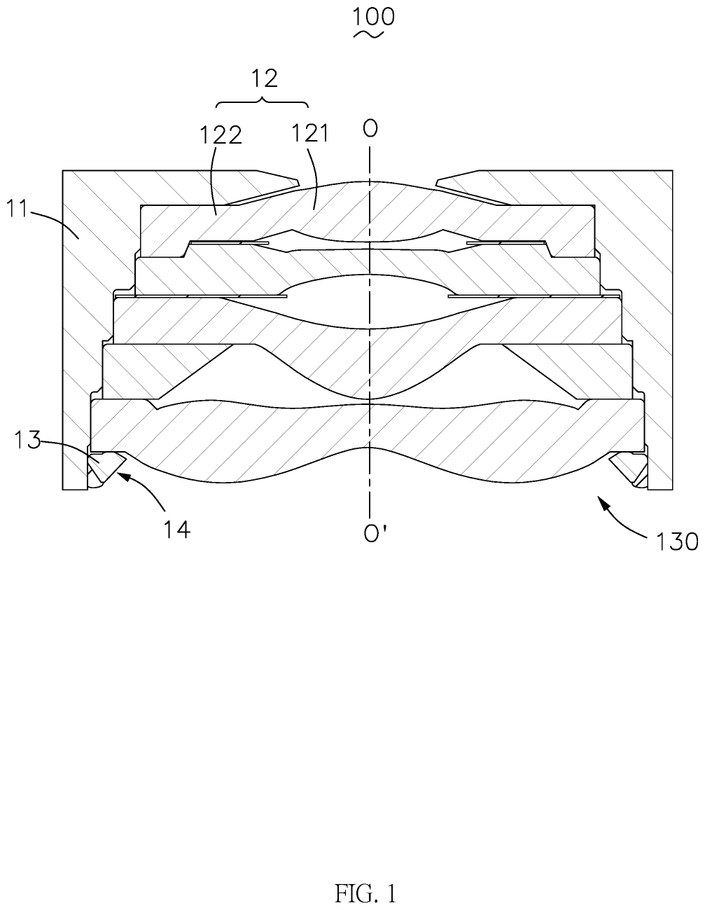

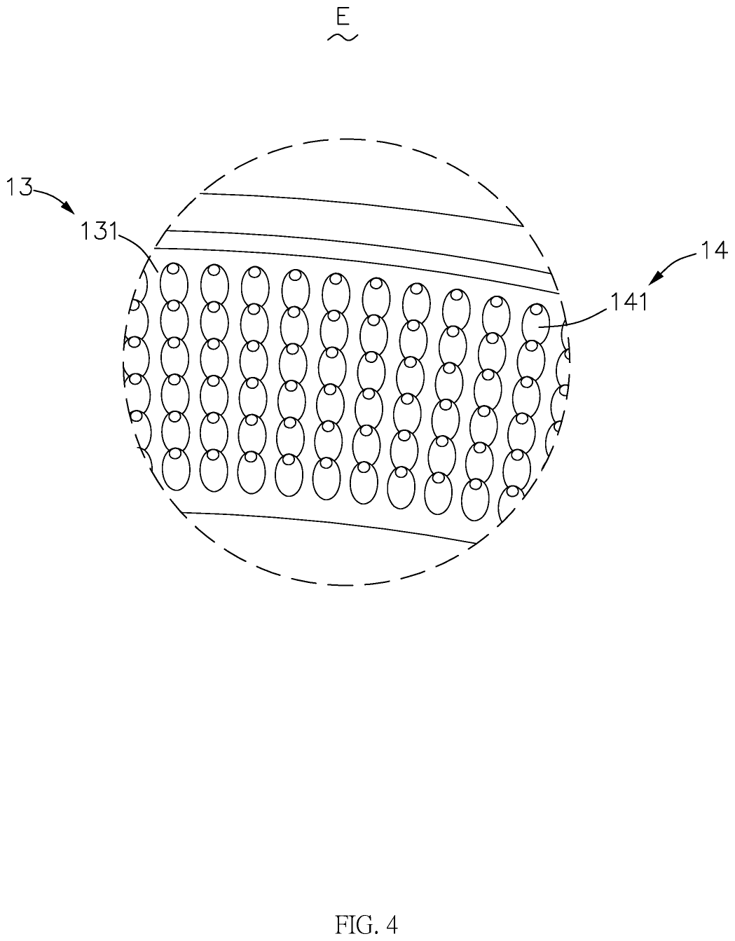

An embodiment of the present disclosure relates to a lens module 100. As shown in FIGS. 1-6, the lens module 100 includes a lens barrel 11 having an optical axis, a lens 12 accommodated in the lens barrel 11 and a pressing ring 13 disposed on an image side of the lens 12. The lens 12 includes a body portion 121 for imaging and a peripheral portion 122 extending around the body portion 121. The body portion 121 constitutes an imaging area. The lens module 100 further has a non-imaging area. The non-imaging area includes the lens barrel 11, the peripheral portion 122 and the pressing ring 13. The lens module 100 further includes an extinction portion 14 provided in the non-imaging area. A plurality of extinction bulges 141 is formed by extending from a side, close to the optical axis OO′, of the extinction portion towards the optical axis OO′. The plurality of extinction bulges 141 is distributed in an array. An end surface, close to the optical axis OO′, of each extinction bulge 141 is an arc surface protruding in a direction facing away from the extinction portion 14.

In this embodiment, the extinction portion 14 is formed in the non-imaging area of the lens module 100 and includes the plurality of extinction bulges 141, the plurality of extinction bulges 141 extends from the surface of the non-imaging area towards the optical axis OO′, and the end surface, close to the optical axis OO′, of the extinction bulge 141 is the arc surface protruding in the direction facing away from the extinction portion 14. In this way, the roughness of the surface of the non-imaging area is increased by arranging the plurality of extinction bulges 141 in an array in the non-imaging area. Thus, the light incident into the lens barrel 11 and onto the surface of the non-imaging area is unlikely to be reflected by the roughed surface of the non-imaging area to form stray light, which may interfere the imaging of the lens module 100, thereby reducing the reflected stray light in the lens barrel 11 and improving the imaging quality.

The details of the present embodiment are specifically described below. The following content is merely intended to facilitate understanding of the provided implementation details, and is not intended to limit the present disclosure.

In this embodiment, the lens module 100 includes the lens barrel 11, the lens 12, the pressing ring 13 and the extinction portion 14.

The lens barrel 11 encircles a receiving space. A plurality of optical components, such as the lens 12, the pressing ring 13 and a light-shading sheet, are disposed in the receiving space. A light-passing hole 10 is formed on a side of the lens barrel 11 close to an object side. Light from the object side is incident into the lens barrel 11 through the light-passing hole 10, then passes through the lens 12, and is imaged on an image side of the lens barrel 11, as shown in FIG. 1.

The lens 12 is accommodated in the lens barrel 11 and configured to optically image. A plurality of lenses 12 forms a lens group. The lens 12 has an optical axis OO′. In the embodiment, the lens group shares a common optical axis OO′. In the embodiment, the lens 12 includes the body portion 121 and the peripheral portion 122. The body portion 121 is configured for imaging. The peripheral portion 122 surrounds the body portion 121 and extends in a direction facing away from the optical axis OO′. The body portion 121 constitutes the imaging area. The peripheral portion 122 is in the non-imaging area.

For example, the lenses 12 can be a convex lens or a concave lens. The convex lens has a positive focal length, and the concave lens has a negative focal length. The values of the focal length are not be specified herein. In practice, the lens group having the required optical parameters can be formed by selecting and combining optical parameters such as the focal length of individual lens 12, which will not be specifically limited herein. In addition, the lens 12 may be a glass lens or a plastic lens. The glass lens has the advantages of wear prevention, wear resistance and deformation resistance. The plastic lens has the advantage of low cost. The specific lens can be selected according to actual needs and will not be limited herein, either. In addition, the number of the lenses 12 can be one, two, three, four, five, etc. In the present embodiment, four lenses 12 are provided. It should be understood that the present embodiment is merely illustrative and is not intended to limit the solution. In other embodiments, there can be other numbers of lenses 12, which will not be described in detail herein.

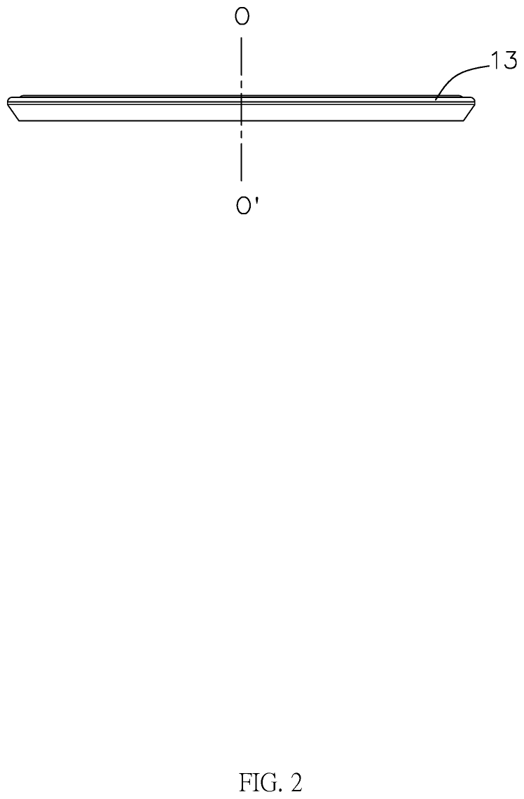

The pressing ring 13 includes an inner side surface 131 around and opposite to the optical axis OO′. The light-passing hole 130 is formed in the inner side surface 131. The inner side surface 131 obliquely extends from the object side in the direction facing away from the optical axis OO′. That is, the inner side surface 131 faces the image side. In addition, the light-passing hole 130 defined by the inner side surface 131 roughly has a shape of a cone and shares the same optical axis OO′ with the lens 12. An opening of the light-passing hole 130 close to the image side is larger than an opening close to the object side. In the present embodiment, the pressing ring 12 is annular, as shown in FIGS. 2, 3 and 5.

In the present embodiment, the pressing ring 13 is disposed on the image side of the lens 12 closest to the image side. Thus, the pressing ring 12 can press and hold the optical components, for example, the lens 12, in the lens barrel 11, so as to fasten the optical components such as the lens 12. That is, the pressing ring 13 functions to stabilize the structures inside the lens module 100.

The pressing ring 13 is fixedly connected to the inner wall of the lens barrel 11 facing the optical axis OO′. For example, the pressing ring 13 can be connected to the inner wall by means of gluing, embedding or the like. No matter which connection means is chosen, a groove can be formed at a position of the inner wall corresponding to the pressing ring 13 to fix the pressing ring 13, as long as the pressing ring 13 can be firmly fixed to the inner wall. In addition, the pressing ring 13 can be a metal or plastic pressing ring, which will not be limited herein.

The extinction portion 14 is disposed in the non-imaging area and configured to weaken the reflected stray light inside the lens barrel 11.

In the present embodiment, the extinction portion 14 is disposed on the pressing ring 13. It can be understood that a photosensitive element for imaging is usually disposed on the image side of the lens module 100. Since the pressing ring 13 is closer to the image side than other optical components, the arrangement of the extinction portion 14 on the pressing ring 13 close to the image side facilitates the weakening of the stray light nearby the photosensitive element of the lens module 100, which is conducive to the optical imaging. It can be understood that the above description is merely a preferred example, but not intended to limit the solutions of other embodiments. In other embodiments, the extinction portion 14 can be disposed in a different position of the non-imaging area, which will not be described in detail herein.

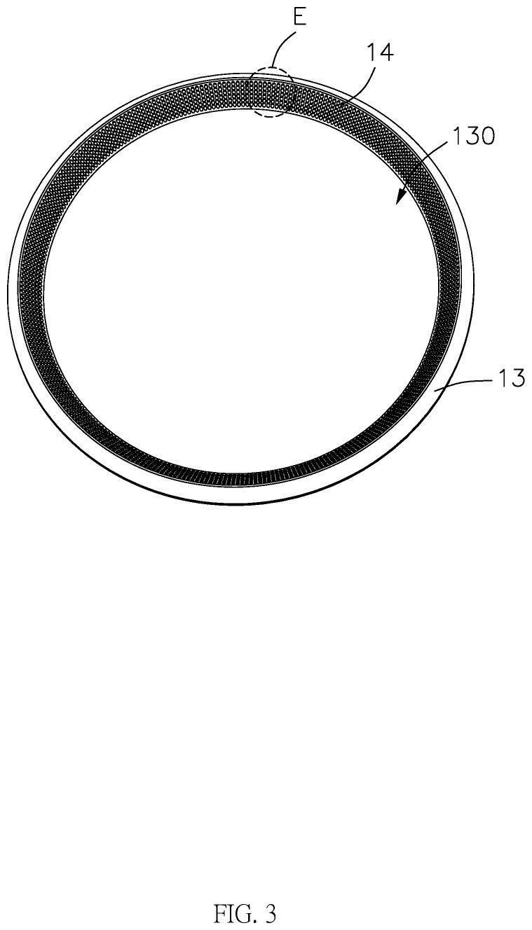

Further, the extinction portion 14 is disposed on the inner side surface 131 of the pressing ring 13, as shown in FIGS. 3-5. It can be understood that light incident into the lens barrel 11 will be incident onto the image side of the lens module 100 through the light-passing hole 130 of the pressing ring 13. That is, the light incident onto the image side of the lens module 100 is likely to be reflected at the light-passing hole 130 of the pressing ring 13, so as to form the reflected stray light. Thus, when the extinction portion 14 is disposed on the inner side surface 131 that defines the light-passing hole 130, the reflected stray light, which may interfere the imaging of the lens module 100, can be effectively weakened.

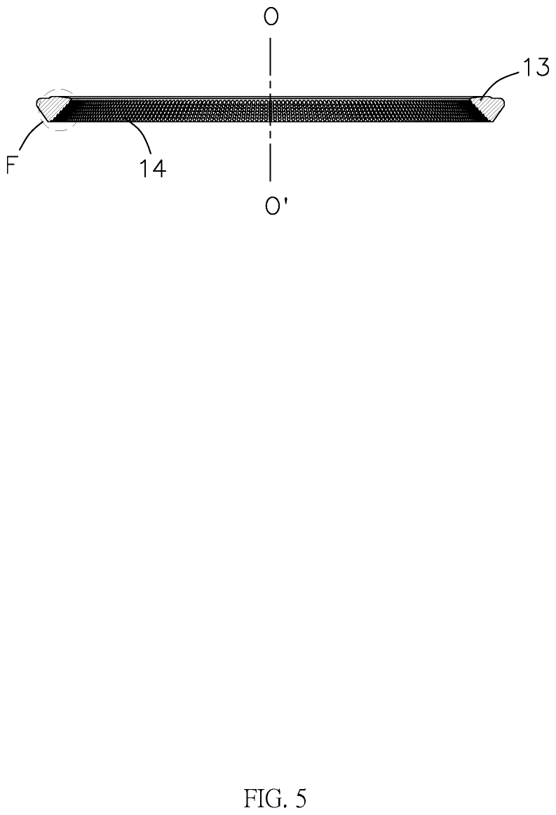

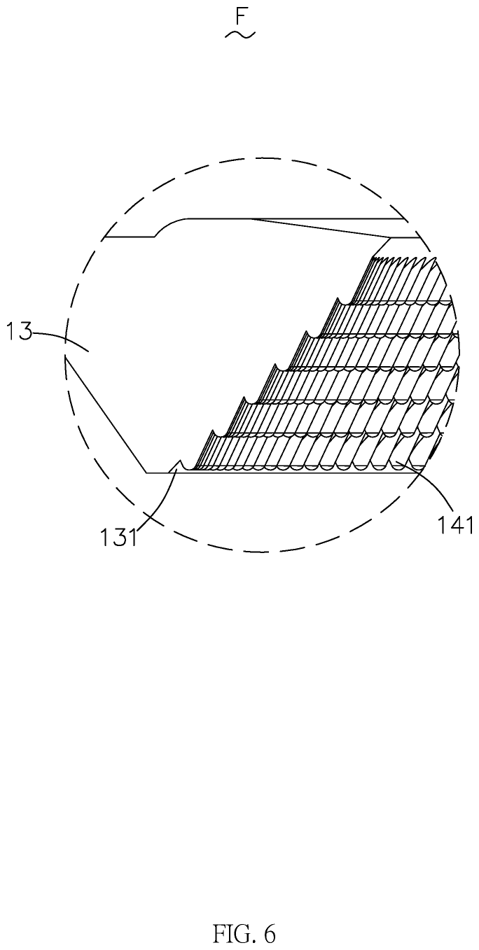

The extinction portion 14 includes a plurality of extinction bulges 141. The plurality of extinction bulges 141 is distributed along the inclined inner side surface 131. Each extinction bulge 141 may extend in a demolding direction. For example, in the present embodiment, the plurality of extinction bulges 141 is distributed in an array and extends towards the optical axis OO′, as shown in FIGS. 5 and 6, thereby facilitating the demolding during manufacture. In the present embodiment, the extinction bulge 141 has an end surface of a tail end extending towards the optical axis OO′, and the end surface is an arc surface protruding in the direction facing away from the extinction portion 14. It can be understood that, compared with a sharp structure, the arc surface is smoother. In this regards, when the tail end of the extinction bulge 141 close to the optical axis OO′ is designed as the arc surface, hands of an operator can be protected from being punctured or scratched, and other optical components also can be protected from being scratched, either.

In the present embodiment, the surface of the extinction portion 14, as well as the surface of the extinction bulges 141, are coated with a black coating. In other words, the extinction portion 14 and the extinction bulge 141 have black material surfaces. Since the color of black has a favorable light-absorbing effect, the black material surfaces can absorb light incident thereon. On this basis, the extinction bulges 141 on the extinction portion 14 can be utilized to weaken the rest reflected stray light inside the lens barrel 11, such that the stray light reflected by the black material surfaces can be reduced. Therefore, the imaging quality can be improved.

The extinction bulges 141 can have various specific structures. For example, the extinction bulge 141 may have a shape of a cone having an arc surface top. In the present embodiment, each extinction bulge 141 has the shape of a cone having the arc surface top. The “top” is the end surface of the tail end of the extinction bulge 141 that extends towards the optical axis OO′. It can be understood that “a cone having an arc surface top” is merely an example, and is not intended to limit the solution in other embodiments. In other embodiments, the extinction bulge 141 may adopt other specific structures, which will not be described in detail herein.

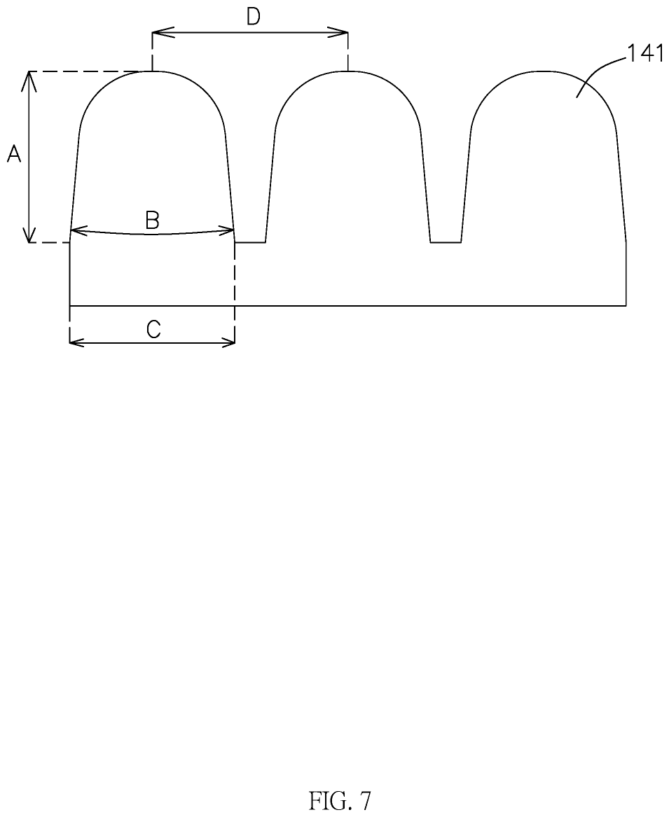

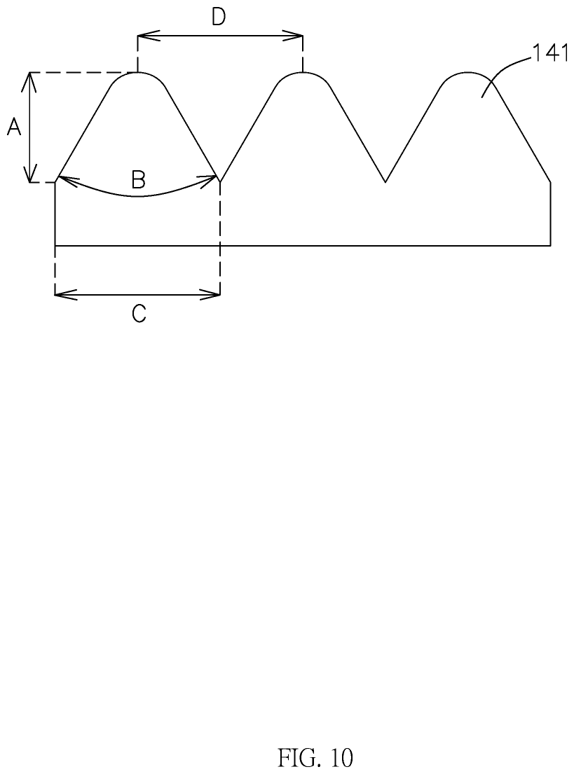

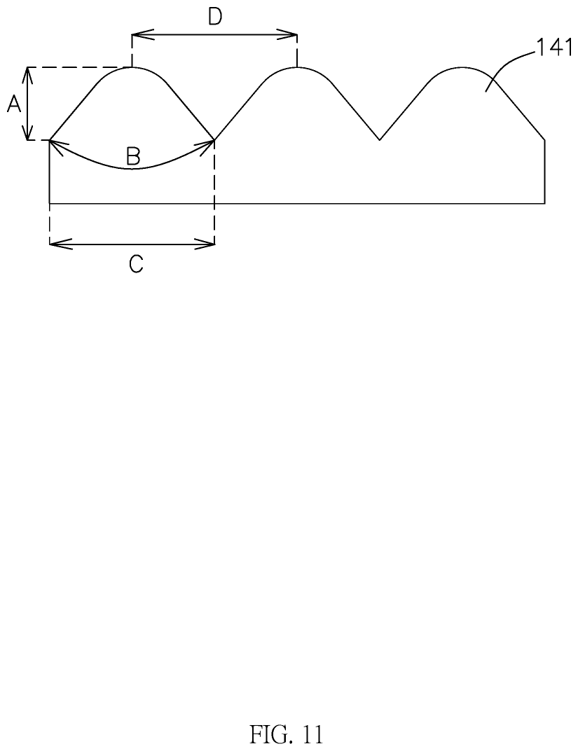

The extinction bulge 141 in shape of “a cone having an arc surface top” may have various specific structures, as shown in FIGS. 7-11. In order to better illustrate the specific structures of the extinction bulge 141 in shape of “a cone having an arc surface top”, the present embodiment further provides ranges of sizes of the extinction bulge 141. A projection of the extinction bulge on a plane parallel to the optical axis OO′ has a length of 10 μm to 30 μm. It should be noted that, on the side of the inner side surface 131 close to the optical axis OO′, the extinction bulges 141 closer to the optical axis OO′ have different height from those farther from the optical axis OO′. The length of the projection described herein refers to the maximum size of the extinction bulge 141 protruding from the inner side surface 131 in the direction of the optical axis OO′, as marked with the reference A in FIGS. 7-11. In addition, in the present embodiment, the extinction bulge has a vertex angle of 0° to 90°. It should be noted that the vertex angle refers to an angle formed by crossing two opposite generatrices of the “cone” in the “cone having an arc surface top”, as marked with the reference B in FIGS. 7-11. A projection of the extinction bulge on a plane perpendicular to the optical axis OO′ has a shape of a circle having a diameter of 20 μm to 40 μm, as marked with the reference C in FIGS. 7-11. The distance, on the plane perpendicular to the optical axis OO′, between vertexes of any two adjacent extinction bulges is in a range of 20 μm to 100 μm, as marked with the reference D in FIGS. 7-11.

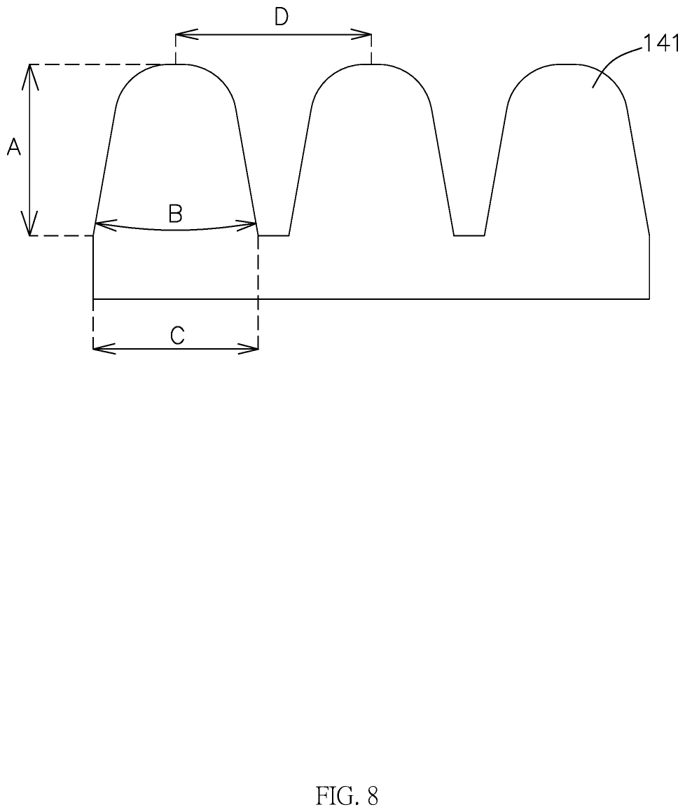

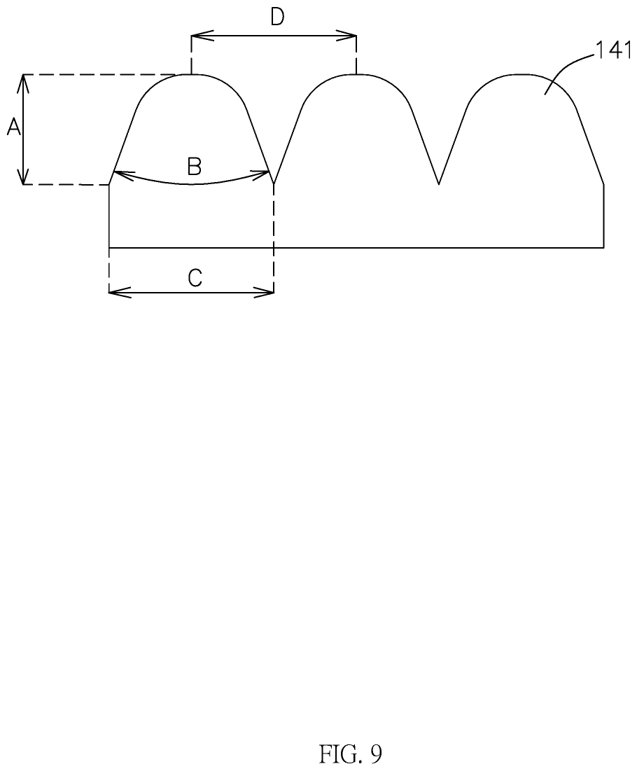

In addition, in the present embodiment, the adjacent extinction bulges 141 may be arranged according to actual demands. For example, any two adjacent extinction bulges are spaced apart from each other, as shown in FIGS. 7 and 8. In another embodiment, any two adjacent extinction bulges abut against each other, as shown in FIGS. 9-11. The arrangement can be chosen according to actual demands and will not be specifically limited herein.

In the present embodiment, the specific number of the extinction bulges 141 can be chosen according to actual demands. The sizes denoted with the reference A, B, C and D and the arrangement relationship between the adjacent extinction bulges 141 can also be taken into consideration, as long as the extinction bulges 141 are rougher than the inner side surface 131 and the effect of weakening the reflected stray light after roughening can be achieved. The specific number is neither limited nor described in detail herein.

Those skilled in the art can understand that the above embodiments are specific embodiments of the present disclosure, and various changes with respect to form or detail can be made without departing from the spirit and scope of the present disclosure.

What is claimed is:

1. A lens module, comprising:
a lens barrel having an optical axis,
a lens received in the lens barrel;
a pressing ring disposed on an image side of the lens; and
an extinction portion,
wherein the lens comprises a body portion for imaging, and a peripheral portion extending around the body portion,
the lens module has an imaging area constituted by the body portion, and a non-imaging area, the non-imaging area comprising the lens barrel, the peripheral portion and the pressing ring,
the extinction portion is provided in the non-imaging area, and a plurality of extinction bulges is formed by extending from a side, close to the optical axis, of the extinction portion towards the optical axis, the plurality of extinction bulges being distributed in an array,
an end surface of each of the plurality of extinction bulges close to the optical axis is an arc surface protruding in a direction facing away from the extinction portion.

2. The lens module as described in claim 1, wherein the extinction portion and the plurality of extinction bulges are coated with a black coating.

3. The lens module as described in claim 1, wherein the extinction portion is disposed on the pressing ring.

4. The lens module as described in claim 3, wherein the pressing ring comprises an inner side surface around and facing towards the optical axis,
the inner side surface obliquely extends from an object side towards an image side in a direction facing away from the optical axis, and the extinction portion is disposed on the inner side surface.

5. The lens module as described in claim 4, wherein any two adjacent extinction bulges of the plurality of extinction bulges are spaced apart from each other.

6. The lens module as described in claim 4, wherein any two adjacent extinction bulges of the plurality of extinction bulges abut against each other.

7. The lens module as described in claim 3, wherein each of the plurality of extinction bulges is a cone having an arc-surface top.

8. The lens module as described in claim 7, wherein a projection of each of the plurality of extinction bulges on a plane parallel to the optical axis has a length of 10 μm to 30 μm.

9. The lens module as described in claim 7, wherein each of the plurality of extinction bulges has a vertex angle of 0° to 90°.

10. The lens module as described in claim 7, wherein a projection of each of the plurality of extinction bulges on a plane perpendicular to the optical axis is a circle having a diameter of 20 μm to 40 μm.

11. The lens module as described in claim 7, wherein a distance, on a plane perpendicular to the optical axis, between vertexes of any two adjacent extinction bulges of the plurality of extinction bulges is in a range from 20 μm to 100 μm.
